(19) United States
(12) Patent Application Publication
(10) Pub. No.: US 2022/0229597 A1
(43) Pub. Date: Jul. 21, 2022

(54) MEMORY SYSTEM AND CONTROL METHOD

(71) Applicant: KIOXIA CORPORATION, Tokyo (JP)

(72) Inventor: Yuki KANBE, Fujisawa Kanagawa (JP)

(21) Appl. No.: 17/411,024

(22) Filed: Aug. 24, 2021

(30) Foreign Application Priority Data
Jan. 21, 2021 (JP) 2021-008054

(51) Int. Cl. G06F 3/06; G06F 16/28; G06F 16/23; G06F 16/245; G06F 21/60; G06F 16/22

(52) U.S. Cl. CPC G06F 3/0659; G06F 3/0604; G06F 3/0679; G06F 16/221; G06F 16/2379; G06F 16/245; G06F 21/602; G06F 16/284

(57) ABSTRACT

A memory system includes a nonvolatile memory and a controller configured to control the nonvolatile memory. The controller is configured to construct a relational database, to store the relational database in the nonvolatile memory, to write data into the relational database, and to read data from the relational database, in response to relational database commands received from a host.

### CROSS-REFERENCE TO RELATED APPLICATION

This application is based upon and claims the benefit of priority from Japanese Patent Application No. 2021-008054, filed Jan. 21, 2021, the entire contents of which are incorporated herein by reference.

### FIELD

Embodiment described herein relates to a memory system and a control method.

### BACKGROUND

Recently, a memory system including a nonvolatile memory has been widely used. A memory system such as a hard disk drive (HDD) or a solid state drive (SSD) is used as a storage of an information processing apparatus such as a server or a personal computer.

In addition, interest in data security has increased. Further, regulations for handling personal information, for example, general data protection regulation (GDPR) have become more stringent. Accordingly, a load on a host that stores big data including personal information in a memory system and analyzes the big data, that is, a load on an information processing apparatus such as a server or a personal computer has increased.

### DESCRIPTION OF THE DRAWINGS

FIG. 1 is a diagram illustrating one configuration example of a memory system connected to a host, according to an embodiment.

FIG. 2 is a diagram illustrating a difference in data transmission and reception between the embodiment and a comparative example.

FIG. 3 is a diagram illustrating an example of a command for defining a relational database that can be received by the memory system according to the embodiment.

FIG. 4 is a diagram illustrating an example of a command for inserting data into a relational database that can be received by the memory system according to the embodiment.

FIG. 5 is a diagram illustrating an example of a command for searching for data in a relational database that can be received by the memory system according to the embodiment.

FIG. 6 is a diagram illustrating a list of response permission conditions to a query in the memory system according to the embodiment.

FIG. 7 is a diagram illustrating a response example to a query in the memory system according to the embodiment.

FIG. 8 is a diagram illustrating an example of a procedure when the memory system according to the embodiment receives a query.

### DETAILED DESCRIPTION

Embodiments provide a memory system that can reduce a load on a host and can manage personal information safely and a control method thereof.

In general, according to one embodiment, a memory system includes a nonvolatile memory and a controller configured to control the nonvolatile memory. The controller is configured to construct a relational database, to store the relational database in the nonvolatile memory, to write data into the relational database, and to read data from the relational database, in response to relational database commands received from a host.

Hereinafter, an embodiment will be described with reference to the drawings.

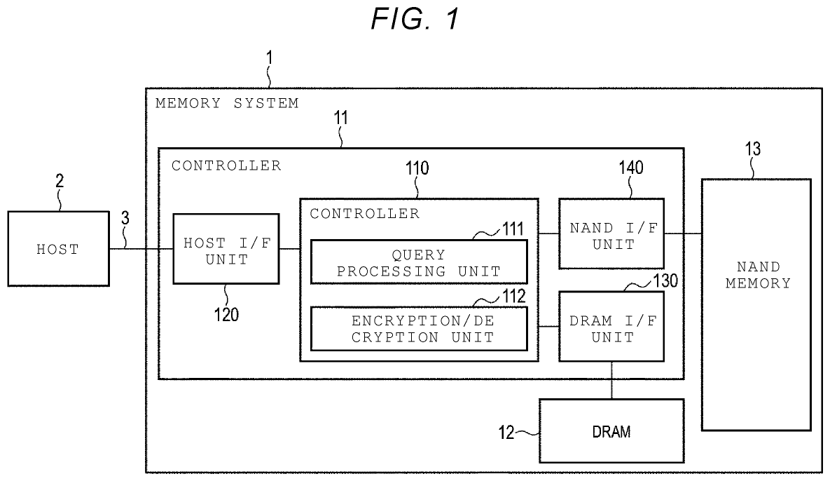

FIG. 1 is a diagram illustrating one configuration example of a memory system 1 according to an embodiment. FIG. 1 also shows one configuration example of an information processing system including: the memory system 1; a host 2 connected to the memory system 1; and an interface 3 that connects the memory system 1 and the host 2 to each other.

The host 2 is an information processing apparatus such as a server or a personal computer.

The interface 3 connects the host 2 and the memory system 1 to each other. The interface 3 is based on, for example, PCI Express (PCIe)® or Ethernet®.

The memory system 1 may be implemented as a storage device such as an HDD or an SSD. Here, an example where the memory system 1 is implemented as an SSD is described. The memory system 1 includes a controller 11, a dynamic random access memory (DRAM) 12, and a NAND-type flash memory (NAND memory) 13.

The controller 11 is configured as, for example, a system-on-a-chip (SoC). Based on a command issued by the host 2, the controller 11 executes, for example, a process of writing data transmitted from the host 2 into the NAND memory 13 or a process of reading data requested by the host 2 from the NAND memory 13.

The controller 11 may encrypt data to be written into the NAND memory 13. When encrypted data is written, the controller 11 decrypts encrypted data read from the NAND memory 13.

The controller 11 includes a control unit 110, a host interface unit 120, a DRAM interface unit 130, and a NAND interface unit 140. The functions of the respective units of the controller 11 may be implemented by dedicated hardware, a processor executing a program, or a combination thereof.

The host interface unit 120 controls communication with the host 2. The host interface unit 120 is based on a unique interface specification having a command format capable of transmitting and receiving a command including a database operation command. The host interface unit 120 may also be based on an existing interface specification such NVM Express (NVMe)® defining a database operation command by using, for example, a vendor unique command.

The database operation command is a command to define or operate a database. The operation of the database includes insertion, deletion, and search (which includes extraction) of data. Examples of a database include a relational database, an object-oriented database, and a key-value database. In the following description, it is assumed that the database is a relational database.

The database operation command can be described by a database language. The database language is, for example, a structured query language (SQL). In addition, the database language employs, for example, an SQL statement. In the following description, it is assumed that the database language employs an SQL statement.

That is, the memory system. 1 according to the embodiment is configured to receive a command including an SQL statement from the host 2. More specifically, in accordance with the SQL statement received from the host 2, the controller 11 constructs a relational database (also referred to as a “table”) or operates a relational database.

The DRAM interface unit 130 controls data access (write/read) to the DRAM 12. The NAND interface unit 140 controls data access to the NAND memory 13.

The control unit 110 is a module that integrally controls the memory system 1. More specifically, the control unit 110 controls the host interface unit 120, the DRAM interface unit 130, and the NAND interface unit 140. The control unit 110 is configured with, for example, one or more processors (not illustrated). By executing a program called firmware or the like, the control unit 110 functions as a query processing unit 111 or an encryption/decryption unit 112. The firmware is loaded from the NAND memory 13 to a memory (not illustrated) in the controller 11 when the memory system 1 is powered on or reset.

The query processing unit 111 executes a process corresponding to an SQL statement transmitted from the host 2. More specifically, the query processing unit 111 constructs a relational database, stores a relational database in the NAND memory 13, writes data into a relational database, or reads data from a relational database. An SQL statement that contains requests to search for and to read desired data from a relational database is also called “query”.

When executing the process corresponding to the SQL statement, the query processing unit 111 in the memory system 1 according to the embodiment may also execute a process for anonymization to implement a function of executing data analysis while protecting personal privacy, for example, Privacy Preserving Data Mining (PPDM). The query processing unit 111 can execute, for example, a process for k-anonymization.

In the k-anonymization, when a database employs a table format of n rows and m columns where each row corresponds to individuals, and each column represents attributes of the individuals, a k−1 or less number of individuals can be prevented from being distinguished from each other. In the k-anonymization, an attribute uniquely representing individuals will be referred to as “identifier”. An attribute that cannot specify one individual but can specify individuals based on a plurality of attributes will be referred to as “quasi-identifier”. A column with a quasi-identifier will also be referred to as “k-anonymity column”. An attribute that is to be kept unknown to other individuals will be referred to as “sensitive attribute”. The sensitive attribute is an attribute including personal information that is an invasion of privacy when disclosed. A column with the sensitive attribute will also be referred to as “hidden column”.

When an SQL statement from the host 2 is a query that requests data of a column with a sensitive attribute, the query processing unit 111 transmits back an error in response to this query. When an SQL statement from the host 2 is a query that requests data of a column with a non-sensitive attribute in addition to data of a column with the sensitive attribute, the query processing unit 111 may transmit back an error or may transmit back only the data of the column with the non-sensitive attribute. That is, the memory system 1 according to the embodiment does not transmit back the data of the column with the sensitive attribute in response to any query.

In addition, when an SQL statement from the host 2 is a query that requests data of a column with a quasi-identifier, the query processing unit 111 determines whether or not the search result satisfies the k-anonymity. The k-anonymity is satisfied when a k−1 or less number of individuals cannot be distinguished from each other based on the data of the column with the quasi-identifier. For example, when quasi-identifiers including “address”, “gender”, and “age” are present, the k-anonymity is satisfied if any combination of attribute values, for example, “Tokyo”, “Male”, and “32 years old” corresponds to a k or more number of individuals. When the search result does not satisfy the k-anonymity, the query processing unit 111 transmits back an error in response to this query. That is, only when the k-anonymity is satisfied, the memory system. 1 according to the embodiment transmits back the data of the column with the quasi-identifier in response to the query. In other words, when the k-anonymity is not satisfied, the memory system 1 according to the embodiment does not transmit back the data of the column with the quasi-identifier in response to the query.

Further, if a generalization is specified for a column, when data is written into the column or data is read from the column, the query processing unit 111 executes a process of generalization based on a predesignated rule. For example, in the case of data of a column with a quasi-identifier of “age”, the generalization refers to a process of processing data such that data of 10 to 19 is converted into teenagers and data of 20 to 29 is converted into twenties. If the generalization is executed when data is read from a column, since an original value is stored in a relational database, the rule of generalization can be dynamically set. For example, the granularity of the above-described data of the column with the quasi-identifier of “age” can also be divided such that data of 10 to 14 is converted into data of 10 and data of 15 to 19 is converted into data of 15. Instead of the query processing unit 111, this generalization may be executed by the host 2 that requests to insert data into a relational database using an SQL statement.

The controller 11 uses the DRAM 12 as a work area when operating a relational database or encrypting or decrypting data. The work area may be a static random access memory (SRAM; not illustrated) in the controller 11. That is, the DRAM 12 is not essential in the memory system 1.

The encryption/decryption unit 112 encrypts data to be written into a relational database, and decrypts data that is read from the relational database when the data that is read is encrypted. The query processing unit 111 transmits and receives data to and from the encryption/decryption unit 112 via the DRAM 12. More specifically, the query processing unit 111 stores, in the DRAM 12, data to be written into a relational database in the NAND memory 13, and requests the encryption/decryption unit 112 to encrypt the data in the DRAM 12. The query processing unit 111 writes the data encrypted by the encryption/decryption unit 112 into the relational database in the NAND memory 13. In addition, the query processing unit 111 stores, in the DRAM 12, the encrypted data that is read from the relational database in the NAND memory 13, and requests the encryption/decryption unit 112 to decrypt the data in the DRAM 12. The query processing unit 111 searches for data corresponding to a query from the host 2 using the data decrypted by the encryption/decryption unit 112.

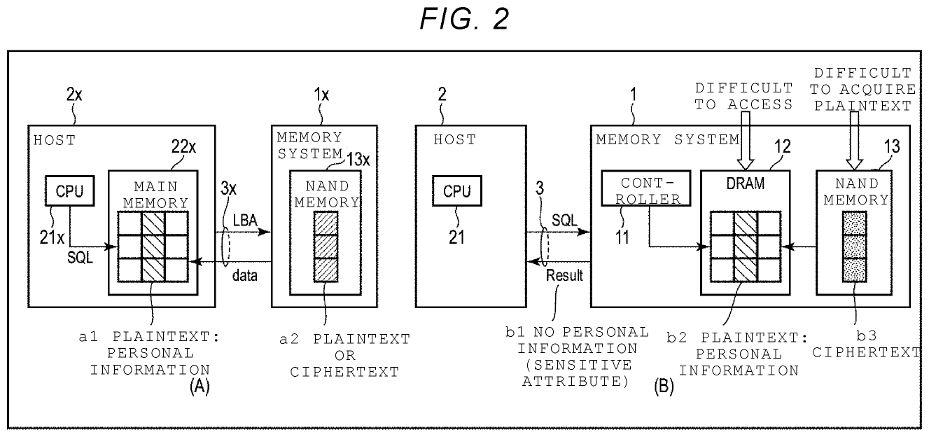

FIG. 2 is a diagram illustrating one comparative example relating to data transmission and reception between the information processing system including the memory system 1 according to the embodiment and an information processing system including a memory system 1x according to a comparative example.

Section (A) of FIG. 2 illustrates the information processing system according to the comparative example where the memory system 1x and a host 2x are connected via an interface 3x. The host 2x transmits a read command or a write command including a logical address correlated with data to be accessed to the memory system 1x. An example of the logical address is a logical block address (LBA).

In the information processing system according to the comparative example, the host 2x executes a process corresponding to an SQL statement. That is, for the process corresponding to the SQL statement, resources of the host 2x, for example, a CPU 21x or a main memory 22x are used. In addition, the host 2x executes the process for anonymization. For example, when an SQL statement issued by a data mining program is a query that requests data of a column with a sensitive attribute, the host 2x executes a process of generating an error. In addition, when the SQL statement issued by the data mining program is a query that requests data of a column with a non-sensitive attribute in addition to data of a column with a sensitive attribute, the host 2x generates an error or executes a process of extracting the data of the column with the non-sensitive attribute.

In addition, in the information processing system according to the comparative example, the host 2x executes a process for anonymization relating to data of a column with a quasi-identifier when a database is constructed. Accordingly, it is difficult to dynamically execute the k-anonymization, for example, to change the rule of generalization. In addition, when it is determined in the host 2X whether or not the search result corresponding to the query satisfies the k-anonymity, and error is generated for the query upon the search result not satisfying the k-anonymity, a load on the CPU 21x further increases. In addition, for example, it is also necessary to prepare a program that executes a process of anonymization suitable for data stored for data mining.

In addition, in the information processing system according to the comparative example, to execute a search corresponding to the query, the host 2x issues a read command designating a logical address (LBA) to the memory system 1x. The host 2x stores data transmitted from the memory system 1x in response to the read command in the main memory 22x. When data is encrypted and stored in a NAND memory 13x of the memory system 1x, the host 2x decrypts the encoded data transmitted from the memory system 1x to execute search corresponding to the query. That is, there is a period of time that plaintext data (a1) is present in the main memory 22x. Accordingly, personal information may be present in the main memory 22x in the form of plaintext, and there is a risk of leakage of the personal information to the outside. In addition, the encrypting or decrypting of data also increases a load on the CPU 21x.

When data is encrypted or decrypted by the memory system 1x, a load on the CPU 21x in the host 2x can be reduced. However, this configuration is the same as described above from the viewpoint that there is a period of time that personal information is present in the main memory 22x of the host 2x in the form of plaintext. In addition, when data (a2) is stored in the NAND memory 13x in the form of plaintext, personal information in the form of plaintext may be compromised if the memory system 1x or the NAND memory 13x is removed and stolen.

On the other hand, section (B) of FIG. 2 illustrates the information processing system including the memory system 1 according to the embodiment.

In the information processing system depicted in section (B) of FIG. 2, by using the memory system 1 according to the embodiment, anonymization for privacy-preserving data mining is implemented. Further, safe management of personal information is implemented.

For example, the data mining program operating in the host 2 issues a query that requests data of a column with a sensitive attribute. The host 2 issues this query (e.g., in the form of an SQL statement) to the memory system 1 as a command.

When a query received from the host 2 is a query that requests data of a column with a sensitive attribute, the memory system 1 transmits back an error in response to this query. When a query received from the host 2 is a query that requests data of a column with a non-sensitive attribute in addition to data of a column with a sensitive attribute, the memory system 1 transmits back an error or transmits back only the data of the column with the non-sensitive attribute.

In addition, the memory system 1 determines whether or not the search result corresponding to the query satisfies k-anonymity, and when the search result does not satisfy the k-anonymity, the memory system 1 transmits back an error in response to this query.

That is, in the information processing system including the memory system 1 according to the embodiment, the host 2 may transmit the query to the memory system 1 irrespective of anonymization. That is, simply by using the memory system 1 according to the embodiment, a privacy-preserving data mining function that executes data analysis while protecting personal privacy can be implemented. In addition, a load on the CPU 21 can be reduced.

In addition, the search result (depicted “Result” in FIG. 2), which satisfies the k-anonymity and does not include the data of the column with the sensitive attribute, is transmitted back to the host 2 (b1). Accordingly, there is no opportunity that the personal information (more generally, sensitive attribute) is present in the host 2. That is, the risk of leakage of personal information in the host 2 can be reduced. In addition, unlike a memory in the host 2 where various programs may be executed by the CPU 21, the DRAM 12 of the memory system 1 can exclude unauthorized access under the control of the controller 11. Therefore, the risk of leakage of the personal information (b2) from the DRAM 12 can also be reduced. In addition, encrypted data is stored in the NAND memory 13 (b3). Therefore, even when the memory system 1 or the NAND memory 13 is removed and stolen, personal information is not compromised even when it is in the form of plaintext.

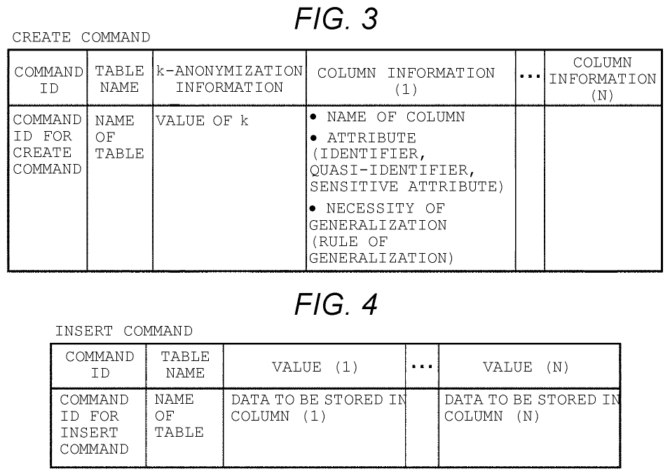

FIG. 3 is a diagram illustrating an example of a command for defining a relational database that can be received from the host 2 by the memory system 1 according to the embodiment.

FIG. 3 illustrates, a “CREATE” command for defining the relational database. The CREATE command includes a command ID for the CREATE command, a name of the table (table name), k-anonymization information, and one or more pieces of column information.

The command ID is identification information uniquely representing the CREATE command.

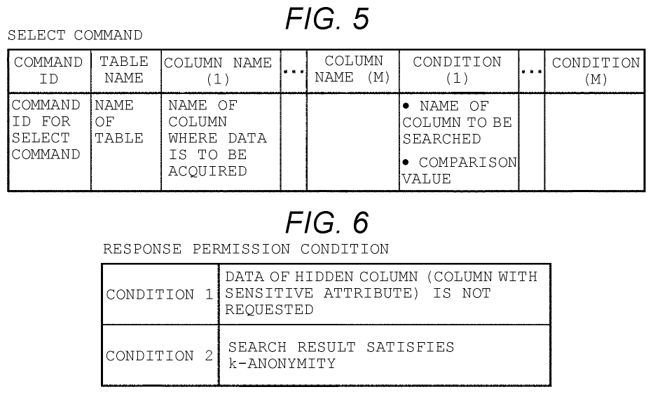

The name of the table is information for designating a certain table from a plurality of tables. The name of the table is used, for example, for inserting (e.g., using an INSERT command) or searching for (e.g., using a SELECT command) data. Examples of the INSERT command and the SELECT command will be described below with reference to FIGS. 4 and 5.

The k-anonymization information is a set value of k. For example, when “2” is set to the k-anonymization information, the process of anonymization is executed such that two or less individuals cannot be distinguished from each other.

The column information includes information representing a name of a column, an attribute, and necessity of generalization. The name of the column is information for designating a certain column from a plurality of columns. The name of the column is used, for example, for searching for (e.g., using the SELECT command) data. The attribute is information representing whether the column is any one of an identifier, a quasi-identifier, or a sensitive attribute. The necessity of generalization is information representing whether or not to execute generalization on data. When the generalization is to be executed, for example, information representing a rule of generalization to be applied among a plurality of rules of generalization is added. Examples of the rules of generalization include: (a) the ages are converted into teenagers, twenties, and the like; and (b) the details of other than city or state information are deleted from the addresses such that only the city or state information remains.

The host 2 can construct various relational databases in the memory system 1 by issuing the CREATE command to the memory system 1 according to the embodiment.

When the memory system 1 receives the CREATE command, a designated table that has a designated name and includes one or more columns corresponding to one or more pieces of designated column information is created and stored in the NAND memory 13. In addition, when acquiring data from this table, the memory system 1 where k-anonymization has been set, k or less number of individuals cannot be distinguished from each other.

The host 2 can store data in the constructed relational database by issuing a command (e.g., the INSERT command) for inserting data into the relational database. At this time, personal information of plaintext is transmitted from the host 2 to the memory system 1. However, by using an existing cryptographic communication technique, leakage of the personal information can be prevented.

FIG. 4 is a diagram illustrating one example of the INSERT command. The INSERT command includes a command ID for the INSERT command, a name of a table (table name), and one or more values.

The command ID is identification information uniquely representing the INSERT command.

The name of the table is information for designating a certain table from a plurality of tables. In an SQL statement of the INSERT command, the name of the table is designated as, for example, “INTO ‘name of table’”.

The values are data to be stored in columns in the table. In the SQL statement of the INSERT command, the values are designated as, for example, “VALUES (value (1), . . . , and value (N))”.

For example, when an INSERT command “INSERT INTO T1 VALUES (1, ‘abc’, 10) is received for a table that has a name T1 and includes three columns, the memory system 1 inserts a row where “1” is stored in the first column, “abc” is stored in the second column, and “10” is stored in the third column into the table T1. If the process of generalization is executed during writing of data, the memory system 1 which has received an INSERT command processes a value to be written into a column designated for generalization, based on a predesignated rule of generalization.

FIG. 5 is a diagram illustrating an example of the SELECT command. The SELECT command includes a command ID for the SELECT command, a name of a table (table name), names of one or more columns (column names), and one or more conditions.

The command ID is identification information uniquely representing the SELECT command.

The name of the table is information for designating a certain table from a plurality of tables. In an SQL statement of the SELECT command, the name of the table is designated as, for example, “FROM ‘name of table’”.

The name of the column is information for designating a column where data is to be acquired from a plurality of columns in the table. In an SQL statement of the SELECT command, the name of the column is designated as, for example, “SELECT FROM ‘name of table’ name of column (1), . . . , and name of column (M)”. Instead of designating the column where data is to be acquired, an operation of returning the number of rows satisfying a condition can also be designated. In this case, for example, “SELECT FROM ‘name of table’ Count (*) WHERE condition (1), . . . , and condition (M)” is designated.

The condition is information for searching for a certain row from a plurality of rows in the table. Each of the conditions includes a name of a column to be searched and a comparison value. The name of the column to be searched and the name of the column where data is to be acquired may be different from each other. In an SQL statement of the SELECT command, the conditions are designated as, for example, “WHERE condition (1), . . . , and condition (M)”. The memory system 1 reads data of a designated column in a row satisfying the condition. When the condition is not designated, the memory system 1 may read data of the designated column in all the rows.

If the process of generalization is executed during reading of data, the memory system 1 which has received a SELECT command processes a value read from a column designated for generalization, based on a predesignated rule of generalization.

FIG. 6 is a diagram illustrating a list of response permission conditions to a query (e.g., SELECT command) in the memory system 1 according to the embodiment.

As illustrated in FIG. 6, the memory system 1 according to the embodiment has two response permission conditions including condition 1 and condition 2.

Condition 1: data of a hidden column (column with a sensitive attribute) is not requested.

Condition 2: the search result satisfies k-anonymity.

When either or both of the two response permission conditions are not satisfied, the memory system 1 according to the embodiment transmits back, for example, an error in response to the query. Alternatively, the memory system 1 does not transmit data of the column with the sensitive attribute (for example, transmits null data) after transmitting a response of success to the query.

Regarding condition 1, when data of a column with a non-sensitive attribute is also requested, the memory system 1 according to the embodiment may transmit back only the data of the column with the non-sensitive attribute for the query.

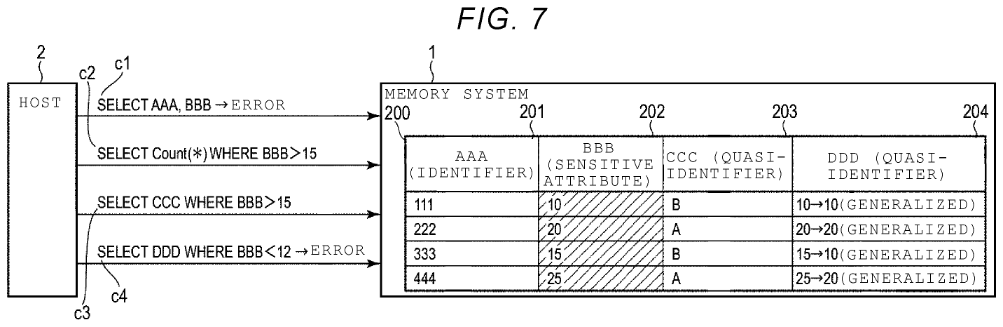

FIG. 7 is a diagram illustrating a response example to a query (e.g., SELECT command) in the memory system 1 according to the embodiment. In FIG. 7, the name of the table among arguments of the SELECT command is not illustrated.

Here, a case where a relational database 200 including columns 201 to 204 is constructed is assumed. The column 201 (name of column: AAA) is an identifier. The column 202 (name of column: BBB) is a sensitive attribute. The column 203 (name of column: CCC) and the column 204 (name of column: DDD) are quasi-identifiers. When data of the column 204 is written into the relational database 200 or is read from the relational database 200, generalization is executed based on a predesignated rule. In addition, it is assumed that “2” is set as the value of k for k-anonymization.

First, a case where a query (c1) that requests data of the column 201 and data of the column 202 is received from the host 2 is assumed. This query requests data of the column 202 with the sensitive attribute. Therefore, the memory system 1 transmits back an error in response to this query. The memory system 1 may transmit back only the data of the column 201 with the non-sensitive attribute.

Next, a case where a query (c2) that requests the number of rows where the value of data of the column 202 is more than 15 is received from the host 2 is assumed. This query does not request the data of the column 202 with the sensitive attribute. In addition, the search result of this query is the number of rows satisfying the search condition (BBB>15) and does not include the data of the columns 203 and 204 with the quasi-identifiers. The rows satisfying the search condition (BBB>15) are the second row and the fourth row. The memory system 1 transmits back “2” as the search result for the query.

Next, a case where a query (c3) that requests data of the column 203 in rows where the value of data of the column 202 is more than 15 is received from the host 2 is assumed. This query does not request the data of the column 202 with the sensitive attribute. On the other hand, the search result of the query includes the data of the column 203 with the quasi-identifier. The rows satisfying the search condition (BBB>15) are the second row and the fourth row. The data of the column 203 in the second row is “A”, and the data of the column 203 in the fourth row is also “A”. Accordingly, less than two individuals cannot be distinguished from each other based on the data of the column 203 with the quasi-identifier in the search result. Accordingly, this search result satisfies the k-anonymity. The memory system 1 transmits back “A” as the data of the column 203 in the second row and “A” as the data of the column 203 in the fourth row as the search result for the query.

Next, a case where a query (c4) that requests data of the column 204 in a row where the value of data of the column 202 is less than 12 is received from the host 2 is assumed. This query does not request the data of the column 202 with the sensitive attribute. On the other hand, the search result of the query includes the data of the column 204 with the quasi-identifier. The row satisfying the search condition (BBB<12) is only the first row. That is, less than two individuals can be distinguished from each other. Accordingly, this search result does not satisfy the k-anonymity. The memory system 1 transmits back an error in response to the query.

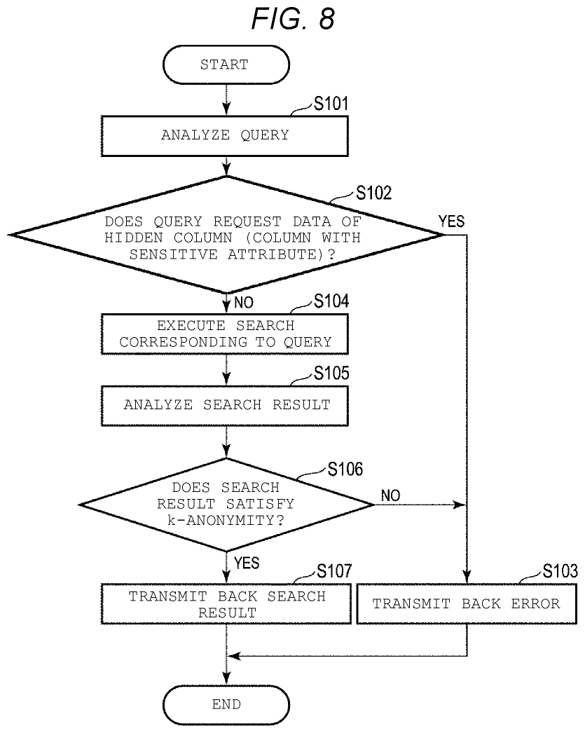

FIG. 8 is a diagram illustrating an example of a procedure when the memory system 1 according to the embodiment receives a query.

The memory system 1 analyzes the received query (S101). More specifically, the query processing unit 111 of the memory system 1 checks whether or not the query requests data of a hidden column (column with a sensitive attribute). When the query requests the data of the hidden column (S102: YES), the memory system 1 transmits back an error in response to the query (S103) and ends the process of the query.

On the other hand, when the query does not request the data of the hidden column (S102: NO), the memory system 1 executes search corresponding to the query (S104). At this time, encrypted data that is read from the relational database in the NAND memory 13 is decrypted and stored in the DRAM 12. The memory system 1 executes the search corresponding to the query using the decrypted data in the DRAM 12.

The memory system 1 analyzes the search result (S105). More specifically, the query processing unit 111 of the memory system 1 checks whether or not the search result satisfies the k-anonymity. When the search result does not satisfy the k-anonymity (S106: NO), the memory system 1 transmits back an error in response to the query (S103) and ends the process of the query.

On the other hand, when the search result satisfies the k-anonymity (S106: YES), the memory system 1 transmits back the search result in response to the query (S107).

In this way, in the memory system 1 according to the embodiment that is configured to receive a command including a statement of a particular database language from the host 2, it is not necessary to execute the process of the query in the host 2. Therefore, consumption of resources of the host 2 can be reduced, and a load can be reduced. During the process of the query, the memory system 1 also executes the process of k-anonymization. Therefore, a load on the host 2 can be further reduced. In addition, since it is not necessary to execute the process of the query in the host 2, there is no period of time that personal information of plaintext is present in the host 2, and thus leakage of the personal information can be prevented. Since the process of k-anonymization is also executed in the memory system 1, k-anonymization can also be dynamically executed.

Further, since data is also encrypted and decrypted in the memory system 1, a load on the host 2 can be further reduced.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a nonvolatile memory; and
a controller configured to control the nonvolatile memory,
wherein the controller is configured to:
in response to relational database commands received from a host,
construct a relational database;
store the relational database in the nonvolatile memory;
write data into the relational database; and
read data from the relational database.

2. The memory system according to claim 1, wherein the controller is configured to:
in response to a first relational database command received from the host, construct the relational database and store the relational database in the nonvolatile memory;
in response to a second relational database command received from the host, write data into the relational database; and
in response to a third relational database command received from the host, read data from the relational database.

3. The memory system according to claim 2, wherein the first relational database command is a structured query language (SQL) statement including a CREATE command, the second relational database command is an SQL statement including an INSERT command, and the third relational database command is an SQL statement including a SELECT command.

4. The memory system according to claim 1,
wherein the controller is further configured to encrypt data to be written into the relational database and to decrypt encrypted data that is read from the relational database.

5. The memory system according to claim 1, wherein
in response to a query from the host that requests data of a column of the relational database that has an attribute of a quasi-identifier, the controller transmits back data of the column that has the attribute of the quasi-identifier to the host when the data of the column that has the attribute of the quasi-identifier satisfies k-anonymity, and transmits back an error to the host when the data of the column that has the attribute of the quasi-identifier does not satisfy the k-anonymity, where k is a value of two or more.

6. The memory system according to claim 5, wherein the value of k is set when the relational database is constructed.

7. The memory system according to claim 1, wherein
in response to a query from the host that requests data of a column of the relational database that has a sensitive attribute, the controller transmits back an error to the host.

8. The memory system according to claim 1, wherein
in response to a query from the host that requests data of a plurality of columns including a column of the relational database that has a sensitive attribute and a column of the relational database that has a non-sensitive attribute, the controller transmits back data of the column that has the non-sensitive attribute to the host and does not transmit back data of the column that has the sensitive attribute to the host.

9. The memory system according to claim 1, wherein
when data is written into a predesignated column of the relational database, the controller generalizes the data and stores the generalized data in the predesignated column of the relational database according to a predesignated generalization rule.

10. The memory system according to claim 1, wherein
when data is read from a predesignated column of the relational database, the controller generalizes the data and transmits back the generalized data to the host according to a predesignated generalization rule.

11. A method of operating a memory system including a nonvolatile memory, said method comprising:
constructing a relational database and storing the relational database in the nonvolatile memory in response to a first relational database command received from a host;
writing data into the relational database in response to a second relational database command received from the host; and
reading data from the relational database in response to a third relational database command received from the host.

12. The method according to claim 11, wherein the first relational database command is a structured query language (SQL) statement including a CREATE command, the second relational database command is an SQL statement including an INSERT command, and the third relational database command is an SQL statement including a SELECT command.

13. The method according to claim 11, further comprising:
encrypting data to be written into the relational database; and
decrypting encoded data that is read from the relational database.

14. The method according to claim 11, further comprising:
in response to a query from the host that requests data of a column of the relational database that has an attribute of a quasi-identifier,
transmitting back data of the column that has the attribute of the quasi-identifier to the host when the data of the column that has the attribute of the quasi-identifier satisfies k-anonymity; and
transmitting back an error to the host when the data of the column that has the attribute of the quasi-identifier does not satisfy the k-anonymity, where k is a value of two or more.

15. The method according to claim 14, further comprising:
setting the value of k when the relational database is constructed.

16. The method according to claim 11, further comprising:
in response to a query from the host that requests data of a column of the relational database that has a sensitive attribute, transmitting back an error to the host.

17. The method according to claim 11, further comprising:
in response to a query from the host that requests data of a plurality of columns including a column of the relational database that has a sensitive attribute and a column of the relational database that has a non-sensitive attribute, transmitting back data of the column that has the non-sensitive attribute to the host.

18. The method according to claim 17, wherein
no data of the column that has the sensitive attribute is transmitted to the host in response to the query.

19. The method according to claim 11, further comprising:
when data is written into a predesignated column of the relational database, generalizing the data and storing the generalized data in the predesignated column of the relational database according to a predesignated generalization rule.

20. The method according to claim 11, further comprising:
when data is read from a predesignated column of the relational database, generalizing the data and transmitting back the generalized data to the host according to a predesignated generalization rule.
